(19) United States
(12) Patent Application Publication
(10) Pub. No.: US 2026/0151983 A1
(43) Pub. Date: Jun. 4, 2026

(54) FLOOR MAT

(71) Applicant: Ningbo Ningyao International Trade Co., Ltd., Ningbo (CN)

(72) Inventor: lina Shi, Ningbo (CN)

(21) Appl. No.: 18/963,868

(22) Filed: Nov. 29, 2024

(51) Int. Cl. B32B 3/08; A47G 27/02; B32B 5/02; B32B 7/022; B32B 13/02; B32B 13/04; B32B 13/12; B32B 13/14; B32B 25/10; B32B 27/12; B32B 27/28

(52) U.S. Cl. CPC B32B 3/085; A47G 27/0243; B32B 5/02; B32B 7/022; B32B 13/02; B32B 13/042; B32B 13/12; B32B 13/14; B32B 25/10; B32B 27/12; B32B 27/283; B32B 2307/536; B32B 2307/7265; B32B 2307/7376; B32B 2471/04

(57) ABSTRACT

A floor mat includes a floor mat main body. The floor mat main body includes a flexible layer and an absorption layer. The absorption layer is used for absorbing liquid. The absorption layer includes a first absorption unit and a second absorption unit. The first absorption unit and the second absorption unit are connected to a surface of the flexible layer. A first gap is defined between the first absorption unit and the second absorption unit. Therefore, when the floor mat is laid on the ground, the floor mat can protect tiles or wooden floor and facilitate a user to move tables and chairs. Moreover, the flexible layer is in contact with the ground, and the absorption layer connected to the flexible layer can absorb liquid, preventing liquid from flowing to the ground, keeping the ground dry, and keeping a surface of the floor mat dry, thus achieving anti-slip effect.

### TECHNICAL FIELD

The present invention relates to the field of protective mats, particularly to a floor mat.

### BACKGROUND ART

With the improvement of living standards, the floor surfaces of the houses where people live are basically paved with tiles or wooden floors, and in daily life, users often use tables and chairs. However, when moving tables and chairs, tiles or wooden floors are often scratched, especially for office chairs with wheels that are more prone to scratching tiles or wooden floors when moving. In addition, in some cases, the ground is relatively smooth when wet, which can easily cause people to fall and keep the ground in a damp state for a long time. Therefore, there is an urgent need on the market to provide a floor mat to protect ceramic tiles or wooden floors, which can facilitate users to move tables and chairs. The floor mat can absorb water, prevent slipping, and prevent water from flowing to the ground, keeping the ground dry and providing anti-slip effect.

### SUMMARY

In order to overcome the shortcomings of the prior art, a floor mat is provided in the present invention. The floor mat includes a floor mat main body. The floor mat main body includes:
a flexible layer; and
an absorption layer, wherein the absorption layer is used for absorbing liquid; the absorption layer includes a first absorption unit and a second absorption unit, the first absorption unit and the second absorption unit are connected to a surface of the flexible layer, and a first gap is defined between the first absorption unit and the second absorption unit.

As an improvement of the present invention, the first absorption unit is rotatable through the flexible layer to be stacked with the second absorption unit.

As an improvement of the present invention, the flexible layer is provided with a first folding part. The first folding part is positioned between the first absorption unit and the second absorption unit. The first absorption unit is rotatable through the first folding part to be stacked with the second absorption unit.

As an improvement of the present invention, the floor mat further includes a first connecting colloid and a second connecting colloid. The first absorption unit is connected to the surface of the flexible layer through the first connecting colloid, and the second absorption unit is connected to the surface of the flexible layer through the second connecting colloid.

As an improvement of the present invention, the first absorption unit is provided with a first lower surface, and the second absorption unit is provided with a second lower surface. The first connecting colloid is arranged around an edge of the first lower surface, and the second connecting colloid is arranged around an edge of the second lower surface.

As an improvement of the present invention, the first connecting colloid is a first waterproof colloid, and the second connecting colloid is the second waterproof colloid.

As an improvement of the present invention, a thickness of the absorption layer is greater than a thickness of the flexible layer.

As an improvement of the present invention, a surface area of the absorption layer is smaller than a surface area of the flexible layer, and a hardness of the absorption layer is greater than a hardness of the flexible layer.

As an improvement of the present invention, the absorption layer further includes third absorption units. The third absorption unit is connected to the surface of the flexible layer, and a second gap is defined between the third absorption unit and the second absorption unit. The second absorption unit is positioned between the first absorption unit and the third absorption unit.

As an improvement of the present invention, the third absorption unit is rotatable through the flexible layer to be stacked with the second absorption unit and/or the first absorption unit.

The flexible layer is further provided with a second folding part. The second folding part is positioned between the second absorption unit and the third absorption unit. The third absorption unit is rotatable through the second folding part to be stacked with the second absorption unit and/or the first absorption unit.

As an improvement of the present invention, the floor mat further includes a third connecting colloid. The third absorption unit is connected to the surface of the flexible layer through the third connecting colloid.

As an improvement of the present invention, the third absorption unit is provided with a third lower surface, and the third connecting colloid is arranged around an edge of the third lower surface.

As an improvement of the present invention, a total number of the third absorption units is multiple, and third gaps are defined between the plurality of third absorption units. The plurality of third absorption units are arranged in sequence along a length direction or a width direction of the flexible layer.

As an improvement of the present invention, the absorption layer is a composite diatomaceous earth absorption layer.

As an improvement of the present invention, the flexible layer includes a cloth layer and a flexible mat body. The cloth layer is positioned between the absorption layer and the flexible mat body. The absorption layer is connected to an upper surface of the cloth layer, and the flexible mat body is connected to a lower surface of the cloth layer.

As an improvement of the present invention, the cloth layer is a water absorbing cloth layer, and the flexible mat body is a rubber flexible mat body or a silicone flexible mat body.

As an improvement of the present invention, the composite diatomaceous earth absorption layer is formed by mixing cement, diatomaceous earth, wood fiber, and slaked lime with each other.

As an improvement of the present invention, the composite diatomaceous earth absorption layer is formed by mixing 10% cement, 35% diatomaceous earth, 35% wood fiber, and 20% slaked lime with each other.

As an improvement of the present invention, a length range of the floor mat main body is 5 cm-1220 cm, a width range of the floor mat main body is 3 cm-790 cm, and a thickness range of the floor mat main body is 0.1 mm-30 cm. A width range of the first gap is 0.1 mm-50 cm. A surface area of the absorption layer is 5%-100% of a surface area of the flexible layer.

As an improvement of the present invention, the length range of the floor mat main body is 50 cm-122 cm, the width range of the floor mat main body is 33 cm-79 cm, and the thickness range of the floor mat main body is 5 mm-3 cm. The width range of the first gap is 2 mm-5 cm. The surface area of the absorption layer is 50%-100% of the surface area of the flexible layer.

Beneficial effects of the present invention are as follows. The floor mat is provided in the present invention. The floor mat includes the floor mat main body. The floor mat main body includes the flexible layer and the absorption layer. The absorption layer is used for absorbing liquid. The absorption layer includes the first absorption unit and the second absorption unit, the first absorption unit and the second absorption unit are connected to the surface of the flexible layer, and the first gap is defined between the first absorption unit and the second absorption unit. Therefore, when the floor mat is laid on the ground, the floor mat can protect tiles or wooden floor and facilitate a user to move tables and chairs. Moreover, the flexible layer is in contact with the ground, and the absorption layer connected to the flexible layer can absorb liquid, preventing liquid from flowing to the ground, keeping the ground dry, and keeping a surface of the floor mat dry, thus achieving anti-slip effect. Furthermore, due to the first gap between the first absorption unit and the second absorption unit, the first absorption unit and the second absorption unit can be folded with each other through the flexible layer to reduce a volume of the floor mat, facilitating transportation, packaging, and storage of the floor mat. Furthermore, due to the contact between the flexible layer and the ground, the flexible layer can act as a buffer, better adhere to the ground, and more effectively protect the ground. Furthermore, due to the first gap between the first absorption unit and the second absorption unit, when the liquid is poured onto the floor mat, the liquid that the absorption layer cannot absorb in time can flow into the first gap, preventing the liquid from overflowing out of the floor mat and keeping a surface of the absorption layer dry, so that the floor mat has an anti-slip effect, the anti-slip effect is more obvious, especially when the floor mat is used in damp working environments such as kitchens.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a schematic diagram of an overall structure of the present invention.

FIG. 2 is a schematic diagram of an overall structure of the present invention when a first absorption unit and a second absorption unit are folded with each other.

FIG. 3 is a schematic diagram of an overall structure of the present invention when a first absorption unit, a second absorption unit, and a third absorption unit are folded with each other.

FIG. 4 is an exploded view of the present invention.

FIG. 5 is another exploded view of the present invention.

FIG. 6 is a sectional view of an absorption layer and a flexible layer.

FIG. 7 is an enlarged view of area A in FIG. 6.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

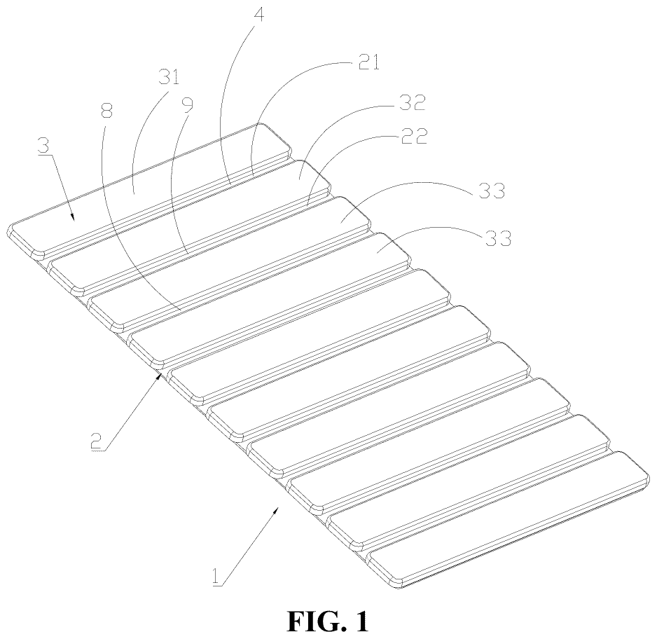

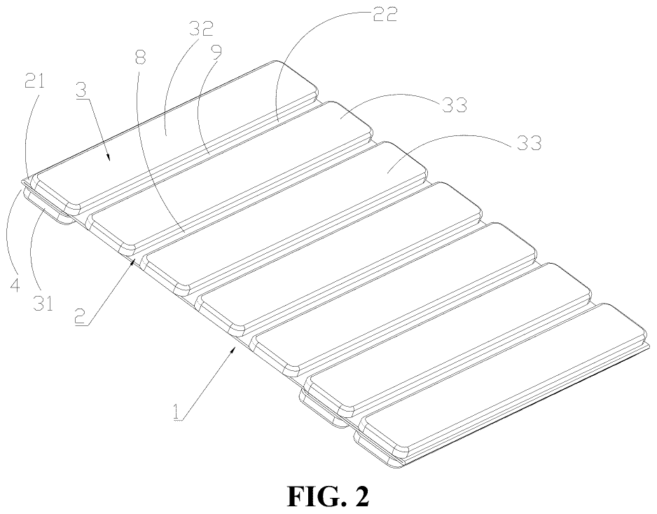

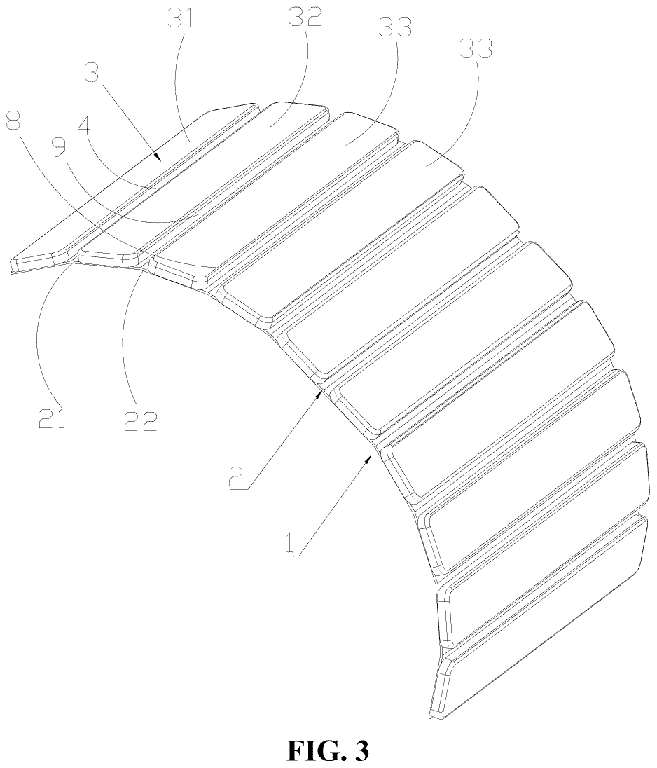

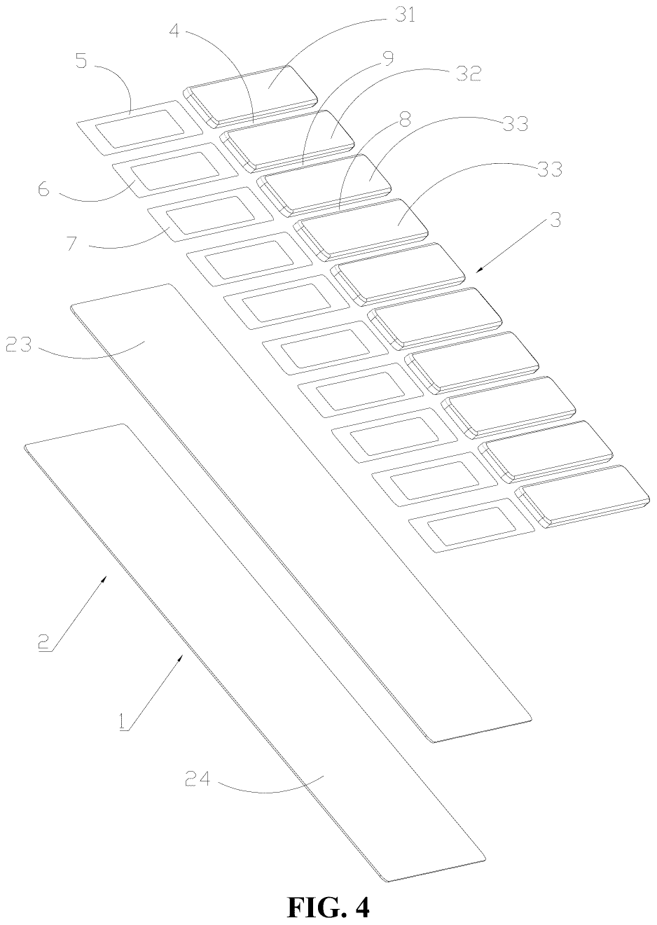

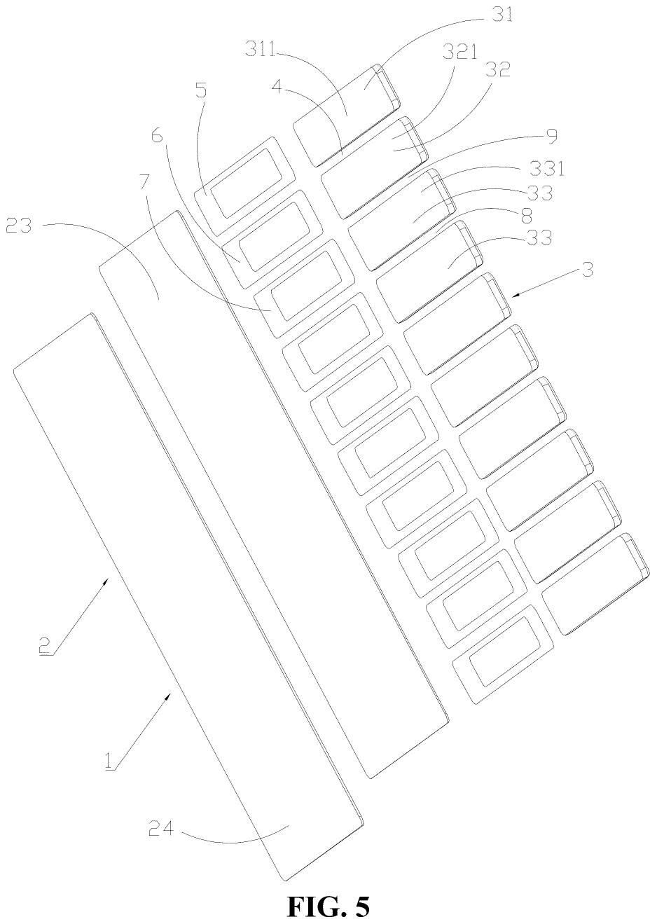

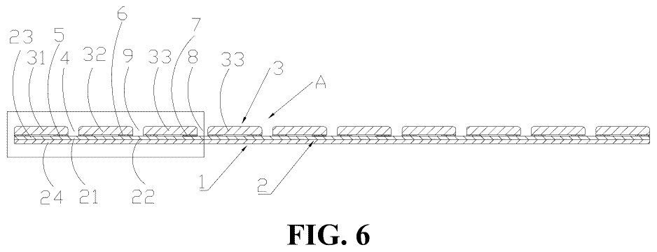

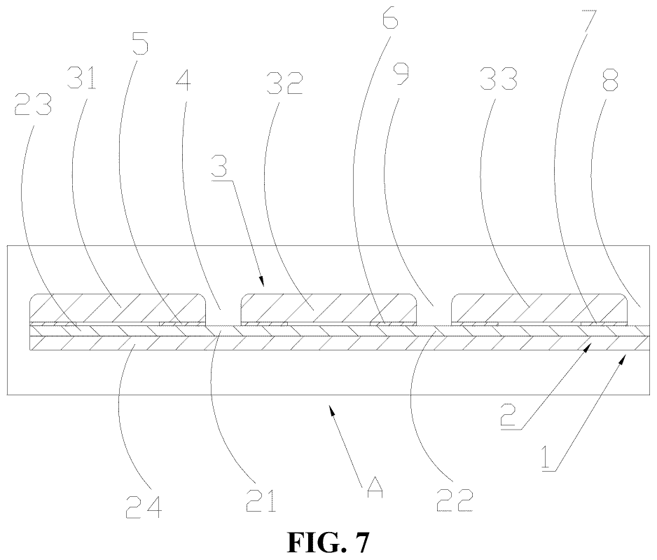

Referring to FIGS. 1-7, a floor mat includes a floor mat main body 1. The floor mat main body 1 includes a flexible layer 2 and an absorption layer 3. The absorption layer 3 is used for absorbing liquid. The absorption layer 3 includes a first absorption unit 31 and a second absorption unit 32, the first absorption unit 31 and the second absorption unit 32 are connected to a surface of the flexible layer 2, and a first gap 4 is defined between the first absorption unit 31 and the second absorption unit 32.

Through the above structure, the floor mat includes the floor mat main body 1. The floor mat main body 1 includes the flexible layer 2 and the absorption layer 3. The absorption layer 3 is used for absorbing liquid. The absorption layer 3 includes the first absorption unit 31 and the second absorption unit 32, the first absorption unit 31 and the second absorption unit 32 are connected to the surface of the flexible layer 2, and the first gap 4 is defined between the first absorption unit 31 and the second absorption unit 32. Therefore, when the floor mat is laid on the ground, the floor mat can protect tiles or wooden floor and facilitate a user to move tables and chairs. Moreover, the flexible layer 2 is in contact with the ground, and the absorption layer 3 connected to the flexible layer 2 can absorb liquid, preventing liquid from flowing to the ground, keeping the ground dry, and keeping a surface of the floor mat dry, thus achieving anti-slip effect. Furthermore, due to the first gap 4 between the first absorption unit 31 and the second absorption unit 32, the first absorption unit 31 and the second absorption unit 32 can be folded with each other through the flexible layer 2 to reduce a volume of the floor mat, facilitating transportation, packaging, and storage of the floor mat. Furthermore, due to the contact between the flexible layer 2 and the ground, the flexible layer 2 can act as a buffer, better adhere to the ground, and more effectively protect the ground. Furthermore, due to the first gap 4 between the first absorption unit 31 and the second absorption unit 32, when the liquid is poured onto the floor mat, the liquid that the absorption layer 3 cannot absorb in time can flow into the first gap 4, preventing the liquid from overflowing out of the floor mat and keeping a surface of the absorption layer 3 dry, so that the floor mat has an anti-slip effect, and the anti-slip effect is more obvious, especially when the floor mat is used in damp working environments such as kitchens.

In this embodiment, the first absorption unit 31 is rotatable through the flexible layer 2 to be stacked with the second absorption unit 32. The flexible layer 2 is provided with a first folding part 21. The first folding part 21 is positioned between the first absorption unit 31 and the second absorption unit 32. The first absorption unit 31 is rotatable through the first folding part 21 to be stacked with the second absorption unit 32. Through the above structure, the foldable structure between the first absorption unit 31 and the second absorption unit 32 is effectively realized, so that the first absorption unit 31 and the second absorption unit 32 can be folded to each other through the flexible layer 2, reducing the volume of the floor mat, and facilitating transportation, packaging, and storage of the floor mat.

In this embodiment, the floor mat further includes a first connecting colloid 5 and a second connecting colloid 6. The first absorption unit 31 is connected to the surface of the flexible layer 2 through the first connecting colloid 5, and the second absorption unit 32 is connected to the surface of the flexible layer 2 through the second connecting colloid 6. The first absorption unit 31 is provided with a first lower surface 311, and the second absorption unit 32 is provided with a second lower surface 321. The first connecting colloid 5 is arranged around an edge of the first lower surface 311, and the second connecting colloid 6 is arranged around an edge of the second lower surface 321. Specifically, the first connecting colloid 5 is a first waterproof colloid, and the second connecting colloid 6 is the second waterproof colloid. Through the above structure, the first absorption unit 31 and the second absorption unit 32 are effectively connected to the flexible layer 2. Moreover, since the first connecting colloid 5 is arranged around the edge of the first lower surface 311 and the second connecting colloid 6 is arranged around the edge of the second lower surface 321, a periphery of the first absorption unit 31 and a periphery of the second absorption unit 32 can be tightly connected to the flexible layer 2. Furthermore, since the first connecting colloid 5 is the first waterproof colloid and the second connecting colloid 6 is the second waterproof colloid, the first waterproof colloid and the second waterproof colloid can remain viscous even after being wet, allowing the first absorption unit 31 and the second absorption unit 32 to be connected to the flexible layer 2 more stably.

In this embodiment, a thickness of the absorption layer 3 is greater than a thickness of the flexible layer 2. Through the above structure, due to the thickness of the absorption layer 3 being greater than the thickness of the flexible layer 2, the thickness of the absorption layer 3 can be increased as much as possible under an identical volume, so that the absorption layer 3 can absorb more liquid.

In this embodiment, a surface area of the absorption layer 3 is smaller than a surface area of the flexible layer 2, and a hardness of the absorption layer 3 is greater than a hardness of the flexible layer 2. Through the above structure, the flexible layer 2 with a larger surface area can cover the ground as much as possible, providing protection for the ground. The absorption layer 3 with a smaller surface area can be placed in various areas of the flexible layer 2 to absorb liquid. Moreover, since the hardness of the absorption layer 3 is greater than the hardness of the flexible layer 2, the combination of the absorption layer 3 with higher hardness and the flexible layer 2 with lower hardness can make an overall hardness of the floor mat more moderate, making user experience of the floor mat better.

In this embodiment, the absorption layer 3 further includes third absorption units 33. The third absorption unit 33 is connected to the surface of the flexible layer 2, and a second gap 9 is defined between the third absorption unit 33 and the second absorption unit 32. The second absorption unit 32 is positioned between the first absorption unit 31 and the third absorption unit 33. The third absorption unit 33 is rotatable through the flexible layer 2 to be stacked with the second absorption unit 32 and/or the first absorption unit 31. The flexible layer 2 is further provided with a second folding part 22. The second folding part 22 is positioned between the second absorption unit and the third absorption unit. The third absorption unit is rotatable through the second folding part to be stacked with the second absorption unit 32 and/or the first absorption unit 31. Specifically, the floor mat further includes a third connecting colloid 7. The third absorption unit 33 is connected to the surface of the flexible layer 2 through the third connecting colloid 7. Furthermore, the third absorption unit 33 is provided with a third lower surface 331, and the third connecting colloid 7 is arranged around an edge of the third lower surface 331. Furthermore, a total number of the third absorption units 33 is multiple, and third gaps 8 are defined between the plurality of third absorption units 33. The plurality of third absorption units 33 are arranged in sequence along a length direction or a width direction of the flexible layer 2. Through the above structure, the arrangement of the third absorption unit 33 is effectively achieved, and the first absorption unit 31, the second absorption unit 32, and the plurality of third absorption units 33 can be folded to each other, reducing the volume of the floor mat, and facilitating transportation, packaging, and storage of the floor mat.

In this embodiment, the absorption layer 3 is a composite diatomaceous earth absorption layer 3. The composite diatomaceous earth absorption layer 3 is formed by mixing cement, diatomaceous earth, wood fiber, and slaked lime with each other. Specifically, the composite diatomaceous earth absorption layer 3 is formed by mixing 10% cement, 35% diatomaceous earth, 35% wood fiber, and 20% slaked lime with each other. Through the above structure, the arrangement of the composite diatomaceous earth absorption layer 3 has been effectively achieved. The diatomaceous earth has better water absorption performance, can quickly absorb liquid, prevent liquid from overflowing out of the floor mat, and a surface of the composite diatomaceous earth absorption layer 3 can still remain dry after the composite diatomaceous earth absorption layer 3 absorbs liquid, providing anti-slip effect. Furthermore, since the composite diatomaceous earth absorption layer 3 contains cement, the cement can facilitate better solidification of the composite diatomaceous earth absorption layer 3, thereby increasing a hardness of the composite diatomaceous earth absorption layer 3. Furthermore, due to the presence of wood fiber in the composite diatomaceous earth absorption layer 3, wood fiber has natural antibacterial and health benefits, can remove odors and has strong water absorption, and wood fiber is renewable, safe, and environmentally friendly. Furthermore, due to the presence of slaked lime in the composite diatomaceous earth absorption layer 3, slaked lime has good water permeability and strong alkalinity, which can effectively inhibit pathogenic bacteria and harmful microorganisms.

In this embodiment, the flexible layer 2 includes a cloth layer 23 and a flexible mat body 24. The cloth layer 23 is positioned between the absorption layer 3 and the flexible mat body 24. The absorption layer 3 is connected to an upper surface of the cloth layer 23, and the flexible mat body 24 is connected to a lower surface of the cloth layer 23. The cloth layer 23 is a water absorbing cloth layer 23, and the flexible mat body 24 is a rubber flexible mat body 24 or a silicone flexible mat body 24. Through the above structure, since the flexible layer 2 includes the water absorbing cloth layer 23, when liquid is poured onto the floor mat, the liquid that the absorption layer 3 cannot absorb in time can flow into the first gap 4, and then be absorbed again by the water absorbing cloth layer 23, so as to prevent the liquid from overflowing from the floor mat and keep the surface of the absorption layer 3 dry, so that the floor mat has an anti-slip effect, and the anti-slip effect is more obvious, especially when the floor mat is used in damp working environments such as kitchens. Furthermore, the rubber flexible mat body 24 or the silicone flexible mat body 24 has a soft texture, long service life, and is not prone to bacterial growth. The absorption layer 3, the water absorbing cloth layer 23, and the flexible mat body 24 are arranged in sequence from top to bottom along a thickness direction of the flexible layer 2.

In this embodiment, a length range of the floor mat main body 1 is 5 cm-1220 cm, a width range of the floor mat main body 1 is 3 cm-790 cm, and a thickness range of the floor mat main body 1 is 0.1 mm-30 cm. A width range of the first gap 4 is 0.1 mm-50 cm. A surface area of the absorption layer 3 is 5%-100% of a surface area of the flexible layer 2. The length range of the floor mat main body 1 is 50 cm-122 cm, the width range of the floor mat main body 1 is 33 cm-79 cm, and the thickness range of the floor mat main body 1 is 5 mm-3 cm. The width range of the first gap 4 is 2 mm-5 cm. The surface area of the absorption layer 3 is 50%-100% of the surface area of the flexible layer 2. Through the above structure, a size of the floor mat is set reasonably, which can meet actual usage needs of the user in different scenarios.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A floor mat, comprising a floor mat main body, wherein the floor mat main body comprises:
a flexible layer; and
an absorption layer, wherein the absorption layer is used for absorbing liquid; the absorption layer comprises a first absorption unit and a second absorption unit, the first absorption unit and the second absorption unit are connected to a surface of the flexible layer, and a first gap is defined between the first absorption unit and the second absorption unit.

2. The floor mat according to claim 1, wherein the first absorption unit is rotatable through the flexible layer to be stacked with the second absorption unit.

3. The floor mat according to claim 2, wherein the flexible layer is provided with a first folding part, the first folding part is positioned between the first absorption unit and the second absorption unit, and the first absorption unit is rotatable through the first folding part to be stacked with the second absorption unit.

4. The floor mat according to claim 1, further comprising a first connecting colloid and a second connecting colloid, wherein the first absorption unit is connected to the surface of the flexible layer through the first connecting colloid, and the second absorption unit is connected to the surface of the flexible layer through the second connecting colloid.

5. The floor mat according to claim 4, wherein the first absorption unit is provided with a first lower surface, the second absorption unit is provided with a second lower surface, the first connecting colloid is arranged around an edge of the first lower surface, and the second connecting colloid is arranged around an edge of the second lower surface.

6. The floor mat according to claim 4, wherein the first connecting colloid is a first waterproof colloid, and the second connecting colloid is the second waterproof colloid.

7. The floor mat according to claim 1, wherein a thickness of the absorption layer is greater than a thickness of the flexible layer.

8. The floor mat according to claim 1, wherein a surface area of the absorption layer is smaller than a surface area of the flexible layer, and a hardness of the absorption layer is greater than a hardness of the flexible layer.

9. The floor mat according to claim 1, wherein the absorption layer further comprises third absorption units, the third absorption unit is connected to the surface of the flexible layer, a second gap is defined between the third absorption unit and the second absorption unit, and the second absorption unit is positioned between the first absorption unit and the third absorption unit.

10. The floor mat according to claim 9, wherein the third absorption unit is rotatable through the flexible layer to be stacked with the second absorption unit and/or the first absorption unit; the flexible layer is further provided with a second folding part, the second folding part is positioned between the second absorption unit and the third absorption unit, and the third absorption unit is rotatable through the second folding part to be stacked with the second absorption unit and/or the first absorption unit.

11. The floor mat according to claim 9, further comprising a third connecting colloid, wherein the third absorption unit is connected to the surface of the flexible layer through the third connecting colloid.

12. The floor mat according to claim 11, wherein the third absorption unit is provided with a third lower surface, and the third connecting colloid is arranged around an edge of the third lower surface.

13. The floor mat according to claim 9, wherein a total number of the third absorption units is multiple, third gaps are defined between the plurality of third absorption units, and the plurality of third absorption units are arranged in sequence along a length direction or a width direction of the flexible layer.

14. The floor mat according to claim 1, wherein the absorption layer is a composite diatomaceous earth absorption layer.

15. The floor mat according to claim 1, wherein the flexible layer comprises a cloth layer and a flexible mat body, the cloth layer is positioned between the absorption layer and the flexible mat body, the absorption layer is connected to an upper surface of the cloth layer, and the flexible mat body is connected to a lower surface of the cloth layer.

16. The floor mat according to claim 15, wherein the cloth layer is a water absorbing cloth layer, and the flexible mat body is a rubber flexible mat body or a silicone flexible mat body.

17. The floor mat according to claim 14, wherein the composite diatomaceous earth absorption layer is formed by mixing cement, diatomaceous earth, wood fiber, and slaked lime with each other.

18. The floor mat according to claim 17, wherein the composite diatomaceous earth absorption layer is formed by mixing 10% cement, 35% diatomaceous earth, 35% wood fiber, and 20% slaked lime with each other.

19. The floor mat according to claim 1, wherein a length range of the floor mat main body is 5 cm-1220 cm, a width range of the floor mat main body is 3 cm-790 cm, and a thickness range of the floor mat main body is 0.1 mm-30 cm; a width range of the first gap is 0.1 mm-50 cm; and a surface area of the absorption layer is 5%-100% of a surface area of the flexible layer.

20. The floor mat according to claim 19, wherein the length range of the floor mat main body is 50 cm-122 cm, the width range of the floor mat main body is 33 cm-79 cm, and the thickness range of the floor mat main body is 5 mm-3 cm; the width range of the first gap is 2 mm-5 cm; and the surface area of the absorption layer is 50%-100% of the surface area of the flexible layer.
